(19) United States
(12) Patent Application Publication
(10) Pub. No.: US 2012/0091143 A1
(43) Pub. Date: Apr. 19, 2012

(54) No-Spill Drinking Products

(76) Inventor: Nouri E. Hakim, Monroe, LA (US)

(21) Appl. No.: 13/234,513

(22) Filed: Sep. 16, 2011

Related U.S. Application Data
(60) Provisional application No. 61/383,713, filed on Sep. 16, 2010.
(60) Provisional application No. 61/383,936, filed on Sep. 17, 2010.

(51) Int. Cl. B65D 51/16; B23P 17/04

(52) U.S. Cl. 220/373; 29/428

(57) ABSTRACT

Improved no-spill drinking products providing safer no-spill caps, stronger and more durable no-spill caps, no spill caps that are particularly suited to adults, and no-spill caps that are particularly suited to children.

### Related Applications

The present application claims priority of U.S. Provisional Application Ser. No. 61/383,713 filed Sep. 16, 2010, and U.S. Provisional Application Ser. No. 61/383,936 filed Sep. 17, 2010, both of which are fully incorporated herein by reference.

### Field of the Invention

The present invention relates to no-spill drinking products.

### BACKGROUND OF THE INVENTION

No-spill products are well known in the art. In the past, a variety of such products have been developed and marketed. In general, the goal of a no-spill cup is to provide a construction which minimizes or prevents liquid from emerging out of the cup when liquid flow is not desired, i.e. when the user is not drinking. However, though the assemblies of the prior art are intended to avoid such accidents, their construction is such that that they generally do not provide a secure enough protection against undesirable spilling or leakage. Thus, when such cups are inverted, or more significantly, when they are shaken vigorously, liquid will often emerge from them. This can be a particular problem with young children, for whom these cups are usually intended.

To address this problem, the present inventor has previously provided various advances in the art, as disclosed for example in U.S. Pat. Nos. 6,321,931, 6,357,620 and 6,994,225, all of which are fully incorporated herein by reference.

Further thereto, yet further improvements in the art of such no-spill drinking products are provided herein.

### SUMMARY OF THE INVENTION

It is an object of the present invention to provide drinking products which prevent liquid from flowing out of the cup when the user is not drinking.

It is a further objection of the invention to provide an improved construction for no-spill drinking products.

It is a further object of the invention to provide drinking products which minimize and/or eliminate accidental or undesirable liquid flow or spillage.

It is a further object of the invention to provide drinking products which prevent liquid flow from a spout even upon very vigorous shaking of the drinking product.

It is a further object of the invention to provide a cup product which provides the ability to regulate the flow rate of liquid out of the cup.

It is a further object of the present invention to provide a product which can be used by young children, to avoid accidental spills of liquid therefrom.

It is a further object of the present invention to provide drinking products which minimize and/or eliminate accidental or undesirable liquid flow or spillage, while obtaining an easier flow of liquid with less draw of vacuum.

It is a further object of the present invention to provide no-spill drinking cup caps having durable, air-tight seals that prevent liquid or air from flowing between the top of the vessel and the cap.

It is a further object of the present invention to provide no-spill drinking cup caps with spouts that minimize or eliminate the ability or possibility of pulling the spout out of the cap or otherwise detaching the spout from the cap.

It is a further object of the present invention to provide no-spill drinking cup caps with spouts that are suitably sized and shaped for adults, and further permit increased fluid flow for adults who partake in a variety of activities.

It is a further object of the present invention to provide no-spill drinking cup caps made entirely of soft, flexible materials, thereby providing a safer product, particularly for children.

It is a further object of the present invention to provide no-spill drinking cup caps made entirely of soft, flexible, impervious materials, thereby providing a product that is easier to clean and that further prevents migration of bacteria and other harmful pathogens into the material.

It is a further object of the present invention to provide drinking cup caps having improved no-spill spouts, wherein the spouts have more effective drinking and no-spill properties, while being more durable and comprising fewer components.

Further objects of the invention will become apparent in conjunction with the disclosure herein.

To accomplish the above objectives, no-spill products are provided for feeding infants, young children, and adults, as shown in the attached figures. These products include no-spill drinking cups, sports bottles, and any other desired drinking vessel.

In accordance with the invention, improved drinking products are described which provide an extremely secure seal against accidental liquid flow from a cup spout. Further to the invention, a user places his or her mouth against the spout of the product to bite down on the soft material of the spout and to drink liquid out when desired. The spout includes a valve therein, such that the act of biting on the soft spout and/or compression of the soft spout with the tongue causes the valve to open. Upon opening a user can suck liquid out of the spout (i.e. apply negative pressure), to drink comfortably therefrom. In contrast, when not in use, the valve sits in a resting, closed position. In this resting or relaxed state, with no compression applied, the valve sits in a configuration in which fluid is securely blocked from passage out of the drinking product. Thus, when the membrane is placed into the user's mouth, the opening within a depression in the spout tip is forced open, to allow drinking therefrom. At other times (when a user is not drinking), the configuration of the depression forces the opening closed, sealing the membrane into a no-spill position.

In the preferred embodiments of the invention, the valve consists of a depression (also referred to herein as an indentation or dimple) in a flexible material or membrane, the depression having more than one opening therein. The depression is specially configured to maximize its effectiveness as a no-spill valve to prevent undesired liquid flow. These membranes can be provided as part of a drinking vessel, whether for children or adults, such as a trainer cup, sports bottle or so forth. In such drinking vessels, the membranes can be provided as part of a spout or other component of the drinking vessel. In each of these products, the unique construction prevents leakage of fluid when the product is not upright, or when shaken.

With respect to the openings in the membrane, any form of desired opening suitable for passage of a desired level of liquid can be utilized in the valve. The opening can be, for example, a hole, a slit, a slot, an orifice, or so forth. The opening is preferably located in the surface of the membrane within the area of the depression.

In the preferred embodiments of the invention, the drinking product further includes at least one additional valve or vent, wherein the second valve is likewise provided with an opening. Upon application of negative pressure at the top of the valve (i.e. when sucking at the spout), this second valve opens to allow air into the drinking product. In so doing, the second opening acts as an air vent, preventing the formation of a vacuum within that drinking product, which would prevent liquid from flowing out of the product. The opening of this second valve thereby facilitates fluid flow from the spout when negative pressure is applied at the spout. In contrast, when the user is not applying negative pressure at the spout (i.e. when the user is not drinking), this second opening seals. If the user shakes the drinking product to provide positive pressure against the first valve, liquid is nonetheless prevented from emerging from the product. Moreover, the shaking of the vessel (or the turning of the vessel upside down or on its face), forces liquid against the second valve, thereby sealing it against air flow. The sealing of the second valve against air flow, yet further prevents liquid from flowing through the opening.

Thus, in each of the embodiments of the invention, the closed valve position provides an extremely secure seal against fluid leakage, such that inadvertent spills or even deliberate attempts to force liquid outside of the cup, such as by turning the cup upside down, or shaking the cup, are ineffective. At the same time, the invention is designed to make it very easy for babies, children, or adults to comfortably extract the desired amount of liquid.

As a result, the invention provides very secure protection against fluid leakage in drinking products that can be used by individuals of all ages, while still providing a comfortable drinking product. The invention can be used by babies, children of all ages, and adults, and prevents messes whether from an accidentally knocked over product, or other spillage. It also protects users, and babies in particular, from swallowing or accidentally choking on liquid leaking in their mouth from a drinking product while they are sleeping.

In further preferred embodiments of the invention, one (or preferably both) of the valves are located in a soft portion of a hard/soft cap. This cap preferably includes a hard component, such as a ring, and a second component which attaches thereto which is soft. The hard component is provided for attachment on the drinking vessel and further provides a very tight seal between the top of the vessel and the cap by tightly sandwiching the soft component between the top of the vessel and the hard component of the cap. The soft component includes the spout and the second valve. In a further preferred embodiment, one (or preferably both) of the valves are located in an entirely soft cap. The soft cap has a portion which attaches to the drinking vessel, and a second portion that includes the spout and the second valve.

Further objects, features and advantages of the invention will become apparent in conjunction with the detailed disclosure provided herein.

### BRIEF DESCRIPTION OF THE DRAWINGS

FIG. 1 is a top view of one embodiment of an assembled no-spill cap in accordance with the present invention.

FIG. 2 is an exploded, perspective bottom view of the embodiment shown in FIG. 1.

FIG. 3 is a front view of the hard component of the no-spill cap shown in FIG. 1.

FIG. 4 is a side view of the hard component of the no-spill cap shown in FIG. 1.

FIG. 5 is a front view of the soft component of the no-spill cap shown in FIG. 1.

FIG. 6 is a side view of the soft component of the no-spill cap shown in FIG. 1.

FIG. 7 is a bottom view of the assembled no-spill cap shown in FIG. 1.

FIG. 8 is a detailed view of the valve portion of the no-spill cap shown in FIG. 7 with said valve in a closed state.

FIG. 9 is a detailed view of the valve portion of the no-spill cap shown in FIG. 7, with said valve in an open state.

FIG. 10 is a top view of a further embodiment of a no-spill cap in accordance with the present invention.

FIG. 11 is a detailed view of the valve portion of the no-spill cap shown in FIG. 10.

FIG. 12 is a rear view of the spout portion of the no-spill cap embodiment shown in FIG. 10.

FIG. 13 is a side view of the spout portion of the no-spill cap embodiment shown in FIG. 10.

FIG. 14 is a rear view of the base portion of the no-spill cap embodiment shown in FIG. 10.

FIG. 15 is a side view of the base portion of the no-spill cap embodiment shown in FIG. 10.

FIG. 16 is a bottom view of the no spill-cap embodiment shown in FIG. 10.

FIG. 17 is a top view of the spout portion of the no-spill cap embodiment shown in FIG. 10.

FIG. 18 is a top, perspective, detailed view of the spout portion of the no-spill cap embodiment shown in FIG. 10.

FIG. 19 is a top, perspective view of the spout portion of the no-spill cap embodiment shown in FIG. 10.

FIG. 20 is a front view of the spout portion of the no-spill cap embodiment shown in FIG. 10.

FIG. 21 is a side view of the spout portion of the no-spill cap embodiment shown in FIG. 10.

FIG. 22 is a rear view of the spout portion of the no-spill cap embodiment shown in FIG. 10.

### DETAILED DESCRIPTION OF THE INVENTION AND PREFERRED EMBODIMENTS

Further to the present invention, improved drinking products are provided as discussed herein. The no-spill products of the invention include various embodiments of drinking cup caps with a spout for use by children and adults. These drinking cup caps can be used in conjunction with drinking vessels for use by persons of any age and in conjunction with any desired activities. The spout is preferably a soft spout which is part of a partially soft cap, or alternatively, part of an entirely soft cap.

If desired, the embodiments of the drinking cup cap can be used in conjunction with “trainer cups” for the transition period when a child moves from drinking out of a baby bottle to drinking out of a cup. During this period, the child can learn to drink from the cup while the parent need not worry about spillage, due to the presence of the no-spill valve in the no-spill cap. Alternatively, the embodiments of the drinking cup cap can be used in conjunction with cups for adults. Such cups can be provided for use in ordinary activity, during athletic events, or in any other desired context. In a preferred embodiment of the present invention, the shape and size of the spout or mouthpiece is designed for more mature users, and the spout is designed to allow for greater flow of liquid therethrough.

In addition, the drinking vessels can be sold or provided empty, for the user to fill with liquid. Or, they can be sold or provided pre-filled with liquid. For example, they can be used to replace the beverage containers sold in stores that have water, soda, juice, sports drinks, or any other desired liquid, pre-filled therein.

The no-spill products of the invention are each provided with one or more suitably designed no-spill valves. Preferably, the valves themselves are constructed of a flexible material (also referred to herein as a membrane). Thus, a flexible valve can be attached to a rigid material, if desired. Further preferably, however, the valve is part of a portion of a cap which is also flexible. In another preferred embodiment, the entire cap is soft and flexible. The valve is designed to allow fluid flow therethrough when the user is drinking, but is also designed to prevent flow of liquid when drinking is not taking place.

In the preferred embodiments of the invention, the valve is designed to be highly effective against spillage. In these embodiments, liquid flows comfortably through the flexible material during drinking. However, when drinking is not taking place the valve seals tightly against liquid flow. This seal is sufficiently effective such that liquid will not flow even under extremely vigorous shaking.

Further according to the preferred embodiments, the invention is designed such that compression is necessary for fluid to flow through the valve. Further preferably, both compression and suction (negative pressure) are applied by the user for optimal results. Thus, the user compresses the flexible material of the valve with his or her mouth, and also applies negative pressure (suction) at the top of the valve to achieve comfortable liquid flow.

For the valve and vent portions of the cap, any suitable flexible material can be used, such as silicone, latex, rubber, plastic, or so forth. Such materials are preferably soft, elastic, and made of material which is harmless to the user. Preferably, the material is sterilizable (preferably by boiling). The materials may also be transparent or translucent, as desired. Likewise, in certain embodiments of the invention, the same types of materials can be used for the soft spouts and the caps in their entirety.

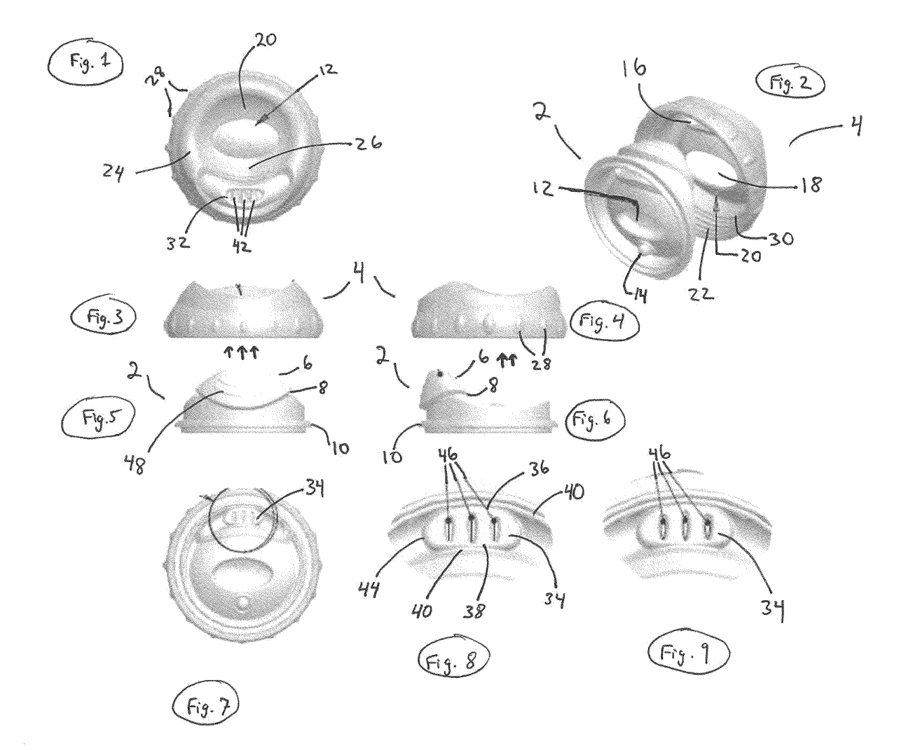

FIGS. 1-9 show one embodiment of the invention, comprising a cap made of two materials, one of which is soft and flexible, the other of which is relatively hard and rigid. The hard portion of this cap is designed to screw onto the top of a drinking vessel, thereby sealing the cap to the vessel.

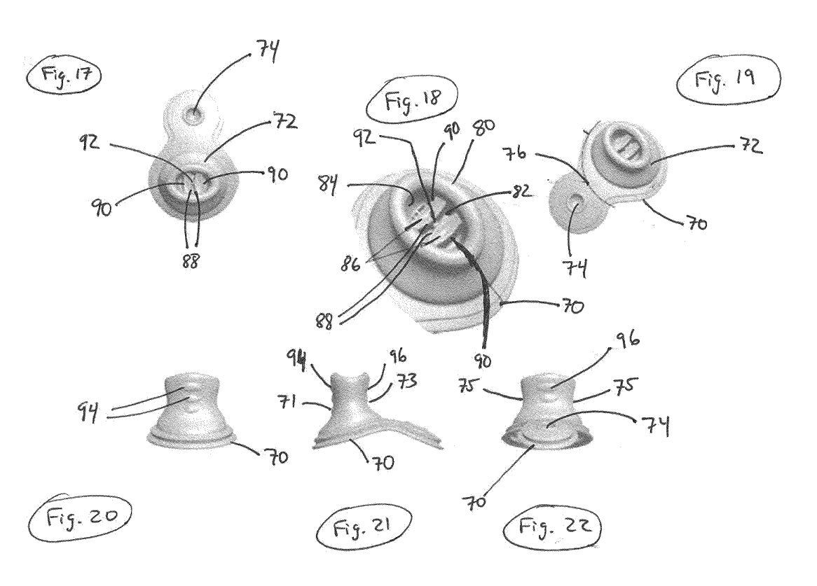

FIGS. 10-22 show a further embodiment of the invention, comprising a cap made entirely of relatively soft and flexible material. The base of the cap of in this embodiment is designed to receive the lip of the top of a drinking vessel, thereby sealing the cap to the vessel.

Referring to FIGS. 1-9, various characteristics of a preferred embodiment of the drinking cap of the present invention are shown. The drinking cap as shown is preferably substantially round, but need not be. Different shapes can be used to fit the tops of different shaped vessels. For example, a vessel with an oblong opening could be mated with a similarly oblong cap, and likewise with other shapes.

The cap comprises a flexible component 2, preferably made from medical grade silicone or the like, and a rigid component 4, preferably made from polypropylene or the like. Preferably, all features of the flexible component 2 are molded together in one setting from the same flexible material. Similarly, all features of rigid component 4 are molded together in one setting from the same rigid material. Flexible component 2 is preferably clear. However, it can also be colored, translucent, and/or opaque. In addition, one or more portions, such as the spout portion 6, can be clear, while other portions might exhibit a different color and/or opacity. Rigid component 4 is preferably opaque, but need not be.

To assemble the cap, flexible component 2 is coupled to rigid component 4 by nesting flexible component 2 snugly inside rigid component 4, as will be described further below. Accordingly, aside from the features of the flexible component 2 described below, the shape of flexible component 2 is substantially similar to that of rigid component 4. Flexible component 2 has a spout portion 6, an upper lip 8 at the base of the spout portion that surrounds the base of the spout, a lower lip 10 that surrounds flexible component 2 near the bottom of said flexible component, an orientating protrusion or hump 12, and a dimple 14 that functions as an air vent. Rigid component 4 has a rim 24 within which there is a substantially circular depressed area 26. The rim 24 is also interrupted by opening 16, in which the spout portion 6 of the flexible component 2 rests when flexible component 2 and rigid component 4 are assembled or coupled together. Depressed area 26 has opening 18 in which orientating hump 12 rests when flexible component 2 and rigid component 4 are assembled or coupled together.

Around the outside of the base of rigid component 4 are one or more protruding finger grips 28 to aid the user in grasping the cap for screwing or unscrewing the cap on, or off, the vessel. On the inside of the base of rigid component 4 are screw threads 22 (preferably of the female variety) for mating with additional screw threads of the opposite variety which would be situated at the top of the vessel, thus allowing the cap to be screwed on, and unscrewed off, the top of the vessel. Accordingly, the size and shape of flexible component 2 relative to the size and shape of rigid component 4 is such that when flexible component 2 is fully nested inside rigid component 4, screw threads 22 are exposed. The screw threads on the vessel are preferably situated a short distance below the rim of the vessel, thereby allowing the top of the rim of the vessel to contact the underside of flexible component 2 when the cap is assembled as in FIG. 1 and fully screwed on to the vessel. This interaction between the rim of the vessel and the underside of flexible component 2 creates an air tight seal that prevents air or liquid from escaping or entering between the top of the vessel and the cap.

Additionally, above screw threads 22 is a groove 30 corresponding to lower lip 10. Lower lip 10 rests in groove 30 when flexible component 2 and rigid component 4 are assembled or coupled together.

Rigid component 4 further has a small hole 20 corresponding to dimple 14. Preferably, the center of dimple 14 lines up with hole 20 when flexible component 2 and rigid component 4 are assembled or coupled together, creating a passage for the flow of air between hole 20 and dimple 14.

To assemble the cap, flexible component 2 and rigid component 4 are provided, each having been molded separately by molding means commonly known in the art. Flexible component 2 is then mechanically or manually nested inside rigid component 4, such that upper lip 8 snaps into place around the edge of opening 16; further such that orientating hump 12 rests and/or snaps into place (in one embodiment, this is accomplished through an additional lip surrounding the base of orientating hump 12) in opening 18, causing orientating hump 12 to protrude through opening 18; and still further such that lower lip 10 snaps into place inside groove 30. In this way, flexible component 2 and rigid component 4 become firmly coupled to each other, with a substantial amount of surface area of rigid component 4 covering flexible component 2, rendering it virtually impossible to pull flexible component 2 through the top of rigid component 4. When flexible component 2 and rigid component 4 are thus coupled, dimple 14 and opening 20 are lined up. Moreover, once flexible component 2 and rigid component 4 have been attached as just described, the cap can be screwed via screw threads 22 (or otherwise secured) onto the top of a vessel, creating an air tight seal between the top of the vessel and the cap.

Referring to FIG. 2, to maximize the effectiveness of the air vent in facilitating drinking, while maintaining the cap's no-spill properties when no one is drinking, dimple 14 is preferably approximately spherically shaped and descends from the top of flexible component 2. It should be understood that other shapes are also suitable for the dimple, such as an ovoid or the like. A slit in the bottom of dimple 14 is provided such that when sufficient negative pressure is created inside the cap and vessel, (such as when the user is drinking), said slit opens, causing the pressure inside and outside the vessel to equalize, thus facilitating drinking. This is accomplished by virtue of a sufficient negative pressure differential between the inside and outside of the vessel causing air to pass into the vessel through hole 20 and the slit in dimple 14. When the cap is not in use, said slit remains closed and sealed due to the nature of the flexible material of flexible component 2 as well as the shape of dimple 14, preventing air or liquid from passing through said slit. Preferably said slit is x-shaped or cross-shaped, but other shaped slits commonly known to those in the art are also suitable.

Orientating hump 18 can be any shape. The surface of orientating hump 18 can also function to display a logo, brand name, and the like. Accordingly, in one preferred embodiment orientating hump 18 is oval or egg shaped.

Referring to FIGS. 1, and 5-9, spout portion 6 has a mouth portion 32. Below mouth portion 32 is a valve comprising a flow membrane 34, said flow membrane having substantially the same size and shape as mouth portion 32. An interior wall 44 descending approximately vertically from mouth portion 32 connects mouth portion 32 to the edge of flow membrane 34, resulting in a flow membrane that is at least partially suspended within spout portion 6. However, to provide a sufficiently large flow membrane for increased fluid flow, at least portions of the front 36 and back 38 portions of the flow membrane's edge rest on the interior wall 40 of spout portion 6. Flow membrane 34 has one or more (preferably three) upward extensions 42. Each extension 42 consists of two walls which are bowed out with respect to each to other, and each said extension is bounded on either side by the front and back, respectively, of interior wall 44. The bowing out of said walls causes said walls to separate when the user applies compression force to the front and back of spout portion 6, creating an opening for fluid flow.

Initially, flexible component 44 is formed such that the tops of each pair of said two walls of extensions 42 are molded together. After molding, slits 46 are made in the tops of extensions 42, said slits running from the front of spout portion 6 to the back of spout portion 6. Thus, in this preferred embodiment, three relatively large drinking slits are provided, allowing for substantial fluid flow while the user is drinking.

When the vessel and cap are assembled but not in use, slits 46 are in a closed position, preventing any liquid flow therethrough. However, when the user applies compression force or pressure to the front and back of spout portion 6, as with, e.g., his or her teeth, lips, or gums, flow membrane 34 flexes, causing slits 46 to open, as shown in FIG. 9, and allowing the user to drink. Flow membrane 34 is sufficiently large and made of sufficiently thick material such that when slits 46 are open, the edge of one slit does not contact or otherwise interfere with the edge of another slit. This lack of interference prevents hindrance of fluid flow that could otherwise be occasioned by slits that interfere with each other, which could thereby cause the openings to decrease in size or close completely while drinking.

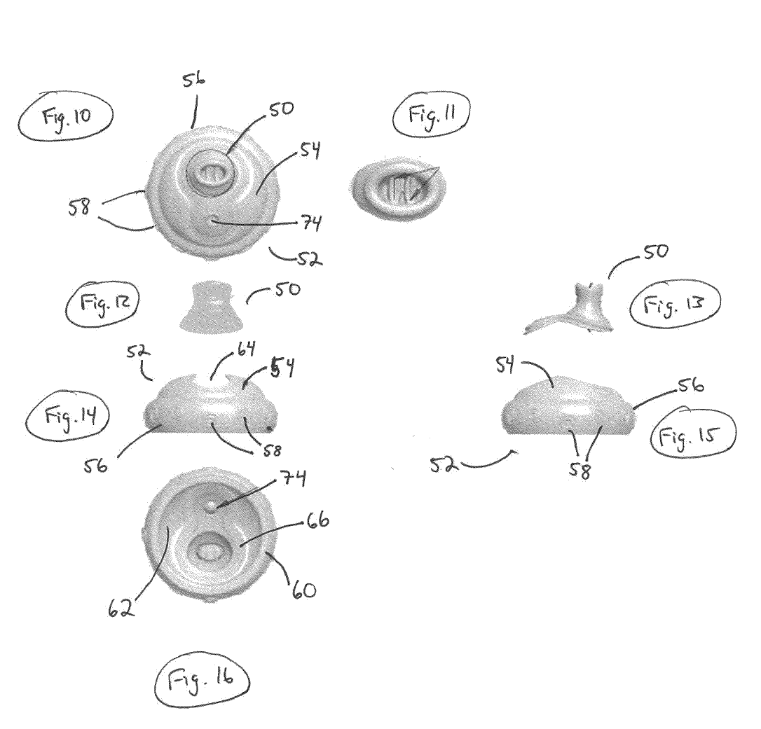

Preferably, the front of spout portion 6 has protruding grips or guides 48. Preferably, similar grips or guides protrude from the back of spout portion 6. These grips or guides can be ribs, as shown in FIG. 5, or alternatively nubs, grooves, or the like. Grips or guides 48 are positioned to guide the user's teeth or lips to the optimal location on the spout portion 6 for drinking. At the same time, grips or guides 48 help keep the user's lips or teeth in the optimal location throughout the drinking process. For optimal drinking, the user should apply pressure with his or mouth, teeth, or lips to the front and back of spout portion 6 approximately along the plane that coincides with the plane containing slits 46. Compression or pressure along this plane directs the user's force directly to the slits and perpendicular to the axis along which slits 46 open, thereby causing and facilitating the opening of slits 46. Accordingly, grips or guides 48 are positioned in order to guide the user's lips or teeth to compress along the aforesaid plane. When the user releases spout portion 6, slits 46 return to their resting, closed position, preventing any fluid flow therethrough. FIG. 8 shows slits 46 in a closed position; FIG. 9 shows slits 46 in an open position.

A further embodiment of the present invention is shown in FIGS. 10-22. In accordance with this embodiment, an improved no-spill cap is provided having a flexible spout portion 50 and a flexible base portion 52. The no-spill cap as shown is substantially round. However, it should be understood to those in the art that caps with other shapes may also be suitable and consistent with this invention, depending on the shape of the vessel to which the cap is coupled.

Spout portion 50, and all of its features to be described herein, is preferably molded in a single setting by insert molding it onto an already formed base portion 52. Furthermore, spout portion 50, and all of its features, are preferably made from clear, relatively low durometer, medical grade silicone, though other strong, flexible, materials known in the art having otherwise different characteristics would also be suitable. Base portion 52, and all of its features to be described herein, is preferably molded in a single setting. Furthermore, base portion 52 and all of its features are preferably made from colored, opaque silicone having a relatively higher durometer than that of spout portion 50, though other strong, flexible materials known in the art having otherwise different characteristics would also be suitable.

Referring to FIGS. 10, 14, 15, and 16, base portion. 52 has dome-shaped top 54, and a ring 56. Ring 56 is preferably relatively thicker than top 54, allowing for an improved seal between ring 56 and the top of the vessel. The precise dimensions and relative dimensions of the various components of the different embodiments of the present invention as described herein, should be readily apparent to one having ordinary skill in the art in view of, and in accordance with, the disclosure herein. Ring 56 has grips 58, which facilitate grasping the ring while attaching or detaching ring 56 from the vessel. Grips 58 can protrude, as shown in the Figures, but any suitable form of grip, such as nubs, bumps, indentations, grooves, or the like, would also be suitable. The particular shape, design and positioning of grips 58 can vary in accordance with cosmetic, aesthetic, commercial or similar needs.

Referring to FIG. 16, base portion 52 has a lower rim 60. Immediately inside rim 60, along the internal wall 62 of base portion 52, there is an undercut, groove, or the like, in the flexible material, which allows base portion 60 to be snappingly secured and sealed to the top of the vessel. Said undercut, which extends around the entire base portion 52, receives the lip of the vessel, establishing an air-tight seal therewith.

The top 54 of base portion 52 has an opening 64. The size and shape of opening 64 corresponds to the size and shape of the lower edge 70 of spout portion 50. In the preferred embodiment shown in the drawings, said shape of said opening 64 resembles a larger circle connected to a smaller circle, or a lop-sided figure-8. Preferably, though not necessarily, a narrow strip of top 54 surrounding opening 64 is slightly recessed, thereby being slightly lower than the surrounding material of top 54. The underside of said recessed portion 66 is shown in FIG. 16. The surface of said recessed portion provides a greater surface area with which to establish a cohesive bond between spout portion 50 and base portion 52 when spout portion 50 is insert molded onto base portion 52 (described below).

Spout portion 50 has a spout 72 and dimple or vent 74. The characteristics, features, and functionality of dimple or vent 74, as well as variations thereof and preferred characteristics, are as described above with reference to the dimple and vent of the embodiment shown in FIGS. 1-9.

Spout portion 50 has lower edge 70, which is slightly lower than, or recessed from, the main surface 76 of spout portion 50. Lower edge 70 corresponds to recessed portion 66 in base portion 52. To attach spout portion 50 to base portion 52, thereby making the no-spill cap of this embodiment, base portion 52 is provided as described above. Base portion 52 is then inserted in a mold, and spout portion 52 is insert molded, or molded by similar means commonly known in the art, to base portion 52, creating a Cohesive, airtight bond between the lower edge 70 of spout portion 50 and the edge surrounding the opening 64 of base portion 52. Preferably, said cohesive bond is formed between the bottom and side of lower edge 70 and the top and side of recessed portion 66, thereby providing a stronger cohesive bond due to the larger surface area of cohesion.

Referring to FIGS. 11 and 17-22, it is preferable that spout 72 has an oval or oblong mouth portion 80. Though mouths having other shapes, such as round or race-track in form, would also be suitable, an oval or oblong shape facilitates grasping spout 72 with the user's lips in the proper orientation for allowing liquid flow through the spout.

Below mouth portion 80 is a valve comprising a flow membrane 82, said flow membrane having substantially the same size and shape as mouth portion 80. An interior wall 84 descending approximately vertically from mouth portion 80 connects mouth portion 80 to the edge of flow membrane 82, resulting in a flow membrane that is at least partially suspended within spout 72. Flow membrane 82 has one or more (preferably two) upward extensions 86. Each extension 86 consists of two walls, an inner wall 88 that is approximately convex and an outer wall 90 that is approximately concave (thus bowed out from each other), each of which is bounded on either side by interior wall 84. The concavity and convexity of said walls causes said walls to separate when the user applies force to the front 71 and back 73 of spout 72.

Initially, spout portion 50 is formed such that the tops of each pair of said two walls 88 and 90 of extensions 86 are molded together. After molding, a slit is made in the top of each extension 86. These slits run along the tops of extensions 86 from the front 71 of spout 72 to the back 73 of spout 72. Thus, in this preferred embodiment, two drinking slits are provided, providing optimal fluid flow for children or the like while they drink.

When the vessel and no-spill cap are assembled but not in use, the aforesaid slits are in a closed position, preventing any liquid flow therethrough. However, when a user applies pressure to the front 71 and back 73 of spout 72, as with, e.g., his or her teeth, lips, or gums, flow membrane 82 flexes, causing said slits to open.

In a preferred embodiment, a connecting structure such as a rib 92 as shown in FIG. 18 connects the inner walls 88 of adjacently positioned extensions 86, keeping inner walls 88 substantially stationary when the user applies force to the front 71 and back 73 of spout 72 while drinking. This results in the user's force being directed to the outer walls 90, causing them to flex outward and opening the slits, and prevents the inner walls 88 from interfering with each other, which could eliminate or reduce the size of the slit openings created by the user's compression. Thus, rib 92 functions to direct the compression force applied by the user while drinking to outer walls 90 of extensions 86, thereby causing the slits to open.

The front 71, back, 73, and sides 75 of spout 72 are pinched in in the middle, or concave, as shown in FIGS. 20-22, with the narrowest horizontal cross-section of spout 72 corresponding approximately with the plane on which the user should bite or compress (as described below) to achieve optimal drinking. This concave shape is a significant advance of the prior art in that it greatly improves the force distribution when a user bites or compresses the spout (as described below). In accordance with the invention, the unique shape and design of the spout as set forth in the description of this embodiment directs said compression force almost entirely to opening the valve, with minimal accompanying distortion of the spout or valve, thereby facilitating drinking and fluid flow and vitiating the need for additional force-distributing structures within the spout.

Preferably, the front 71 of spout 72 has protruding grips or guides 94. Preferably, similar grips or guides 96 protrude from the back 73 of spout 72. These grips or guides can be ribs, as shown in FIGS. 20 and 22, or alternatively nubs, grooves, or the like. Grips or guides 94 and 96 are preferably positioned to guide the user's teeth or lips to the location on spout 72 for optimal drinking. At the same time, grips or guides 94 and 96 help keep the user's lips or teeth in the optimal location throughout the drinking process. For optimal drinking, the user should apply pressure with his or mouth, teeth, or lips to the front 71 and back 73 of spout portion 72 approximately along the plane that coincides with the plane containing the aforesaid slits. Compression or pressure along this plane, combined with the concave shape of the spout, directs the user's force directly to the slits and perpendicular to the axis along which said slits open, thereby causing and facilitating the opening of said slits. Accordingly, grips or guides 94 and 96 are positioned in order to guide the user's lips or teeth to compress along the aforesaid plane. When the user releases spout 72, the slits return to their resting, closed position, preventing any fluid flow therethrough.

The embodiment shown in FIGS. 10-22 and described herein is particularly suited for children. The entirely soft cap prevents injury if a child falls or drops the vessel while holding it or drinking from it. In addition, a cap made entirely of medical grade silicone is flexible and therefore easier to clean on the inside and the outside. Moreover, such a material does not allow germs or bacteria to migrate into the material, making the product cleaner and safer for children and other users.

Having described this invention with regard to specific embodiments, it is to be understood that the description is not meant as a limitation since further embodiments, modifications and variations may be apparent or may suggest themselves to those skilled in the art. It is intended that the present application cover all such embodiments, modifications, and variations.

1. A no-spill cap comprising a flexible member and a rigid member,
said flexible member comprising an inner face, an outer face, a spout portion, an air vent, and a lip;
said air vent comprising an outer surface and an inner surface such that said air vent is closed when in a resting position, and such that said air vent is open when negative air pressure is applied to said inner surface;
said rigid member comprising an inner face, an outer face, a first opening, a second opening, and a groove;
wherein said flexible member is coupled with said rigid member by nesting said flexible member within said rigid member such that said spout portion rests inside said first opening, and such that said air vent is aligned with said second opening, and such that said lip is mated with said groove.

2. A no-spill cap as in claim 1, wherein said spout portion comprises a valve that prevents liquid flow therethrough when said valve is in a rest state, and wherein said valve allows liquid flow therethrough when negative air pressure is applied to said valve.

3. A no-spill cap as in claim 1, wherein said rigid member can be coupled to the top of a vessel thereby creating an airtight seal between the top of the vessel and said flexible member.

4. A no-spill cap as in claim 3, wherein said airtight seal is created by sandwiching said flexible member between the top of the vessel and said inner face of said rigid member.

5. A no-spill cap as in claim 1, wherein said flexible member further comprises a protrusion, and wherein said rigid member further comprises a third opening, said protrusion resting in said third opening when said rigid member and said flexible member are nested together.

6. A no-spill cap as in claim 2, wherein said valve comprises a plurality of slits, whereby said slits prevent liquid flow therethrough when said valve is in a rest state, and whereby said slits allow liquid flow therethrough when negative air pressure is applied to said valve.

7. A no-spill cap as in claim 6, whererin said valve comprises three or more slits, said slits sufficiently spaced to prevent the opening of one of said slits from interfering with the opening of the remaining of said slits.

8-10. (canceled)

11. A no-spill cap as in claim 2, wherein said outer face of said rigid member further comprises at least one grip.

12. A no-spill cap as in claim 2, wherein said spout further comprises an outer surface, said outer surface of said spout having at least one grip that situates a person's mouth around said spout for improved optimal liquid flow through said spout.

13. A no-spill cap as in claim 1, wherein said flexible member further comprises a second lip, and said rigid member further comprises a second groove, such that said second lip is mated with said second groove when said rigid member and said flexible member are nested together.

14. (canceled)

15. A no-spill cap comprising a first flexible member and a second flexible member,
said first flexible member comprising a base and a top, said top comprising an opening,
said second flexible member comprising a spout and an air vent,
said air vent comprising an outer surface and an inner surface such that said air vent is closed and airtight when in a resting position, and such that said air vent is open when negative air pressure is applied to said inner surface,
wherein said second flexible member is molded in said opening of said first flexible member to create a no-spill cap.

16. A no-spill cap as in claim 15, wherein said first flexible member further comprises a rim, an inner surface, and an outer surface, said inner surface comprising a groove above said rim for receiving the lip of a vessel to create an airtight seal between said rim and the vessel.

17. A no-spill cap as in claim 16, wherein said outer surface of said base further comprises at least one hand grip.

18. A no-spill cap as in claim 16, wherein said outer surface of said first flexible member comprises a depressed strip, said depressed strip surrounding said opening in said top, and wherein said second flexible member comprises an outer edge, said outer edge comprising a lip, wherein said lip is molded to said depressed strip to create a no-spill cap.

19. A no-spill cap as in claim 16, wherein said spout has an outer wall, said outer wall having a substantially concave shape,

20. A no-spill cap as in claim 19, wherein said spout further comprises a valve, said valve comprising a membrane, said membrane comprising a plurality of slits, whereby said slits prevent liquid flow therethrough when said membrane is in a rest state, and whereby said slits allow liquid flow therethrough when negative air pressure is applied to said membrane.

21. (canceled)

22. A no-spill cap as in claim 19, wherein said outer wall further comprises at least one grip that situates a person's mouth around said spout for improved liquid flow through said spout.

23. (canceled)

24. A method comprising the steps of:
molding a first flexible member, said first flexible member having an opening; and
molding a second flexible member into said opening of said first flexible member, said second flexible member comprising a no-spill spout, thereby creating a cohesive bond between said first flexible member and said second flexible member to create a no-spill cap.

25. A method as in claim 24, wherein said molding of said second flexible member is accomplished by insert molding.

26. A method as in claim 24, further comprising the step of making at least one slit in said second flexible member.

27-29. (canceled)
